(19) United States
(12) Patent Application Publication
(10) Pub. No.: US 2016/0215075 A1
(43) Pub. Date: Jul. 28, 2016

(54) REAGENT FOR ENHANCING GENERATION OF CHEMICAL SPECIES

(71) Applicant: TOYO GOSEI CO., LTD., Ichikawa-shi, Chiba (JP)

(72) Inventor: Takashi Miyazawa, Inzai-shi, Chiba (JP)

(21) Appl. No.: 14/915,496

(22) PCT Filed: Sep. 4, 2014
(86) PCT No.: PCT/JP2014/004563

§ 371 Date: Feb. 29, 2016

Related U.S. Application Data
(60) Provisional application No. 61/959,963, filed on Sep. 5, 2013.

(51) Int. Cl. C08F 2/50; B29C 67/00; C09D 4/00

(52) U.S. Cl. CPC C08F 2/50; C09D 4/00; B29C 67/0066; B29K 2105/0002

(57) ABSTRACT

Described are reagents that generate a chemical species initiating a polymerization of at least one kind of monomer by non-resonant multi-photon excitation of the reagent.

### CROSS-REFERENCE TO RELATED APPLICATIONS

This application is a national phase entry under 35 U.S.C. §371 of International Patent Application PCT/JP2014/004563, filed Sep. 4, 2014, designating the United States of America and published in English as International Patent Publication WO 2015/033570 A1 on Mar. 12, 2015, which claims the benefit under Article 8 of the Patent Cooperation Treaty and under 35 U.S.C. §119(e) to U.S. Provisional Patent Application Ser. No. 61/959,963, filed Sep. 5, 2013, the disclosure of each of which is hereby incorporated herein in its entirety by this reference.

### TECHNICAL FIELD

Several aspects of this disclosure relate to the fields of a reagent that acts as a sensitizer or an initiator for non-resonant multi-photon excitation. Furthermore, several aspects of this disclosure relate to the fields of fabrication methods of a device or structure utilizing non-resonant multi-photon excitation.

### BACKGROUND

There have been attempts to form three-dimensional objects by utilizing two-photon absorptions of materials.

A method for forming three-dimensional objects by utilizing two-photon absorptions of materials is disclosed in U.S. Pat. No. 5,914,807 (filed on Nov. 3, 1997), the contents of the entirety of which are incorporated herein by this reference.

### BRIEF SUMMARY

A reagent relating to an aspect of this disclosure generates a first chemical species by non-resonant multi-photon excitation of the reagent; and the first chemical species initiates polymerization of at least one kind of monomer.

A reagent generates a first chemical species by absorbing a plurality of photons, each of which does not have enough energy to excite to the lowest singlet excited state of the reagent to generate the first chemical species; and the first chemical species initiates polymerization of at least one kind of monomer.

A reagent relating to an aspect of this disclosure is characterized wherein homolytic bond fission of the reagent occurs by absorbing a plurality of photons, each of which does not have enough energy to excite to the lowest singlet excited state of the reagent.

With regard to the reagent, it is preferred that the reagent is characterized wherein a first chemical species is generated through the hemolytic bond fission.

With regard to the reagent, it is preferred that the first chemical species initiates polymerization of at least one kind of monomer.

With regard to the reagent, it is preferred that the first chemical species is a radical.

With regard to the reagent, it is preferred that cleavage of a bond between a carbon atom on an aromatic ring and a halogen atom connected to the carbon atom occurs in the hemolytic bond fission.

With regard to the reagent, it is preferred that the first chemical species initiates polymerization of at least one kind of monomer.

With regard to the reagent, it is preferred that the reagent is characterized wherein the reagent generates a second chemical species.

With regard to the reagent, it is preferred that the second chemical species is acid.

With regard to the reagent, it is preferred that the first chemical species is generated unimolecularly from the reagent.

With regard to the reagent, it is preferred that the first chemical species is generated from the reagent without any interaction with another molecule.

With regard to the reagent, it is preferred that the first chemical species is not generated from the reagent when the reagent is irradiated with a light of which energy is enough to excite to the lowest singlet excited state of the reagent by one-photon absorption.

A composition relating to an aspect of this disclosure includes any one of the above reagents and at least one kind of monomer.

A method for fabricating an object relating to an aspect of this disclosure includes putting any one of the compositions relating to an aspect of this disclosure on a substrate and irradiating the composition three-dimensionally controlling focal positions.

With regard to the method, it is preferred that the irradiating of the composition is carried out such that polymerization of the at least one kind of monomer occurs at the focal positions.

With regard to the method, it is preferred that the irradiating of the composition is carried out by making the reagent absorb a plurality of photons, each of which does not have enough energy to excite to the lowest singlet excited state of the reagent.

A composition relating to an aspect of this disclosure includes any one of the above reagents and a compound.

With regard to the composition, it is preferred that the compound is to react with the second chemical species.

With regard to the composition, it is preferred that the compound has a group that is to react with the second chemical species such that a deprotection reaction of the group occurs.

A method for fabricating an object relating to an aspect of this disclosure includes putting any one of the compositions and irradiating the composition three-dimensionally controlling focal positions.

With regard to the method, it is preferred that the irradiating of the composition is carried out such that the deprotection reaction of the compound occurs at focal positions.

With regard to the method, it is preferred that the irradiating of the composition is carried out by making the reagent absorb a plurality of photons, each of which does not have enough energy to excite to the lowest singlet excited state of the reagent.

A reagent relevant to an aspect of this disclosure generates a chemical species by non-resonant multi-photon (NRMP) excitation of the reagent, for which a light unable to excite the reagent by one-photon excitation is used. In other words, the reagent absorbs a plurality of photons, each of which does not have enough energy to excite to the lowest singlet excited state of the reagent to generate the chemical species. Typically, the chemical species is a reactive intermediate such as radical, ion radical, carbene, silylene, and ion. A more typical example of the chemical species is a radical that is generated directly, unimolecularly or without any interaction with another molecule from the reagent by NRMP excitation. Due to such mechanism for formation of the radical, the formation of the radical from the excited state is very efficient.

Other examples of the chemical species are Bronsted acid, Bronsted base, Lewis acid and Lewis base.

The chemical species can act as an initiator for polymerization of at least one kind of monomer.

Non-resonant two-photon (NRTP) excitation of a typical example of the reagent related to an aspect of this disclosure shows a reaction mode quite different from those that are observed in one-photon reactions. More typical examples are ethenes having at least one aromatic ring and a halogen atom on the at least one aromatic ring. NRTP excitation of such ethenes induces cleavage of bond between the halogen atom and a carbon atom in the at least one aromatic ring while one-photon irradiation of such ethenes induces trans-cis isomerization, intramolecular or intermolecular cyclization reaction.

A composition containing such reagent that can be excited by NRMP excitation and at least one kind of monomer is prepared. NRMP excitation of a coating film of the composition is carried out using an irradiation system that can control focal positions three-dimensionally to form a three-dimensional object or device.

### BRIEF DESCRIPTION OF THE DRAWING

In the drawing that illustrates what is currently considered to be the best mode for carrying out the invention:

FIG. 1 shows an irradiation system for NRTP excitation.

### DETAILED DESCRIPTION

### Experimental Procedures

The reagents that can be excited by NRTP excitation to form chemical species by NRTP excitation of the reagents are prepared as follows:

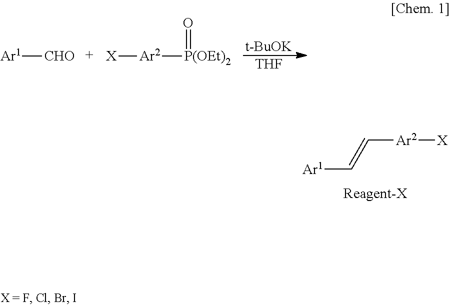

Typical examples of the Ar¹ group of Reagent-X are non-substituted or substituted phenyl group, non-substituted or substituted naphthyl group, and non-substituted or substituted anthryl group, non-substituted or substituted pyrenyl, non-substituted or substituted phenanthryl group, and non-substituted or substituted perylenyl group.

Typically, Ar¹ may contain:
(1) non-substituted or substituted phenyl group and at least one double bond connected to both of the phenyl group and the formyl group; or
(2) non-substituted or substituted naphthyl group and at least one double bond connected to both of the naphthyl group and the formyl group;
(3) non-substituted or substituted anthryl group and at least one double bond connected to both of the anthryl group and the formyl group;
(4) non-substituted or substituted pyrenyl group and at least one double bond connected to both of the pyrenyl group and the formyl group; or
(5) non-substituted or substituted phenanthryl group and at least one double bond connected to both of the pyrenyl group and the formyl group; or
(6) non-substituted or substituted perylenyl group and at least one double bond connected to both of the perylenyl group and the formyl group; or
(7) non-substituted or substituted heterocyclic group

The above (1)-(7) may contain at least one halogen atom.

Typical examples of the Ar² group are non-substituted or substituted phenyl group, non-substituted or substituted naphthyl group, and non-substituted or substituted anthryl group, non-substituted or substituted pyrenyl, non-substituted or substituted phenanthryl group, and non-substituted or substituted perylenyl group.

Typically, Ar² may contain:
(8) non-substituted or substituted phenyl group and at least one double bond connected to both of the phenyl group and the phosphorus atom; or
(9) non-substituted or substituted naphthyl group and at least one double bond connected to both of the naphthyl group and the phosphorus atom;
(10) non-substituted or substituted anthryl group and at least one double bond connected to both of the anthryl group and the phosphorus atom;
(11) non-substituted or substituted pyrenyl group and at least one double bond connected to both of the pyrenyl group and the phosphorus atom; or
(12) non-substituted or substituted phenanthryl group and at least one double bond connected to both of the pyrenyl group and the phosphorus atom; or
(13) non-substituted or substituted perylenyl group and at least one double bond connected to both of the perylenyl group and the phosphorus atom; or
(14) non-substituted or substituted heterocyclic group.

The above (8)-(14) may contain at least one halogen atom in addition to X.

Reagent-X′ can be also used as an initiator for NRTP excitation.

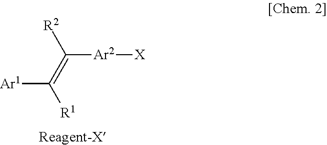

Typically, R¹ may contain:
(15) alkyl group; or
(16) alkenyl group; or
(17) alkynyl group; or
(18) aryl group; or
(19) heterocyclic group.

The above (15)-(19) may contain at least one halogen atom.

Typically, R² may contain:
(20) alkyl group; or
(21) alkenyl group; or
(22) alkynyl group; or
(23) aryl group; or
(24) heterocyclic group; or
(25) hydrogen atom; or
(26) halogen atom.

The above (20)-(26) may contain at least one halogen atom.

One of R¹ and R² may be a hydrogen atom.

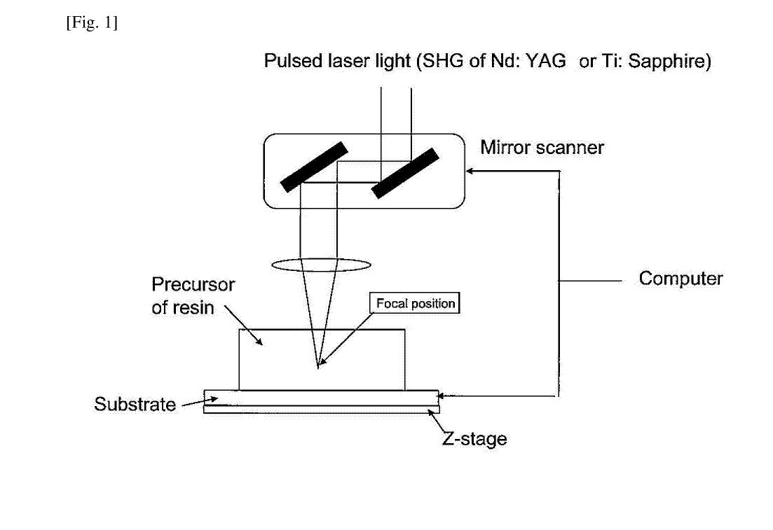

A composition used as a precursor of resin is prepared by dissolving Reagent-X or Reagent-X′ and at least one kind of monomer. The composition is put on a substrate placed on a Z-stage to form a coating film. An NRTP excitation of the coating film is carried out using the irradiation system shown in FIG. 1. The NRTP excitation is carried out three-dimensionally by controlling focal positions in the coating film by mirror scanner and Z-stage on which the substrate is placed as shown in FIG. 1. A pulsed light such as the second harmonic of Nd: YAG laser and Ti:Sapphire is delivered to the irradiation system.

Since the composition does not absorb the used pulsed light by direct one-photon transition, the composition at a desired depth can be irradiated with the used pulsed light. Since polymerization of the at least one kind of monomer uses non-resonant multi-photon (NRMP) by which Reagent-X or Reagent-X′ absorbs photons or non-resonant two-photon (NRTP) excitation with a light that cannot excite Reagent-X or Reagent-X′ by one-photon transition, the efficiency of reaction increases with n-th power or the square of the intensity of the used pulsed light. Therefore, a higher contrast is obtained. An NRTP excitation of Reagent-X or Reagent-X′ results in hemolytic fission of the bond between a halogen atom and a carbon atom connected to the halogen atom to generate a corresponding radical accompanied with halogen radical. Halogen radical is converted to halogen acid. The radical initiates polymerization of monomer or precursor. Therefore, a three-dimensional object or device can be fabricated through an NRTP excitation of Reagent-X or Reagent-X′.

In a typical example, 4-Bromostilbene (4-t-BrS) is used as Reagent-X and at least one of A-DCP or 1,9-ND-A is a precursor of polymer. An NRTP excitation of 4-t-BrS forms a corresponding radical, which initiates polymerization of the monomer.

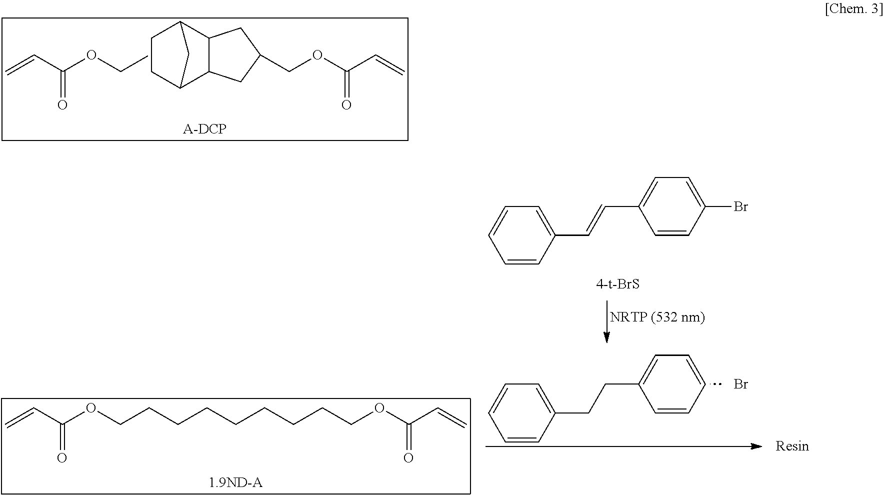

Since an NRTP excitation of Reagent-X also generates acid such as HX (X=halogen), deprotection reaction of a protecting group such as ester and acetal can occur. Therefore, a composition containing Reagent-X and a compound having a protecting group can be used as three-dimensional positive resist.

Styrene derivatives having at least one ring-fused aromatic group can be used as Reagent-X. Typical examples of such compounds are shown below. A pulsed near-infrared light generated by a light source such as Ti:Sapphire can be NRTP excitation of compound having longer conjugation length such as t-XSt-An.

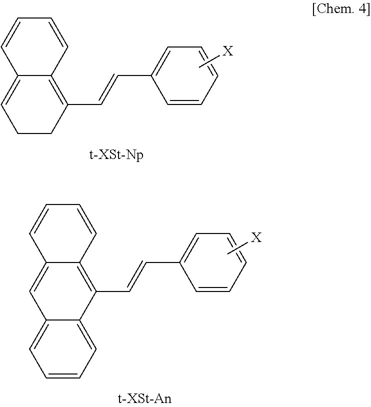

1. The reagent of claim 3, wherein the reagent generates a first chemical species by non-resonant multi-photon excitation of the reagent.

2. The reagent of claim 1, wherein the reagent generates a first chemical species by absorbing a plurality of photons, each of which has insufficient energy to excite to the lowest singlet excited state of the reagent to generate the first chemical species.

3. A reagent, wherein the reagent is characterized in that:
a homolytic bond fission of the reagent occurs by the reagent absorbing a plurality of photons, each of which has insufficient energy to excite to the lowest singlet excited state of the reagent.

4. The reagent according to claim 3, wherein the reagent is characterized in that:
a first chemical species is generated through the homolytic bond fission.

5. The reagent according to claim 3, wherein the homolytic bond fission initiates polymerization of at least one kind of monomer.

6. The reagent according to claim 4, wherein the first chemical species is a radical.

7. The reagent according to claim 3, wherein:
the reagent includes an aromatic ring and a halogen atom connected to a carbon atom included in the aromatic ring; and
a cleavage of a bond between the carbon atom and the halogen atom connected to the carbon atom occurs in the homolytic bond fission.

8. (canceled)

9. The reagent according to claim 3, wherein the reagent is characterized in that:
the reagent generates a second chemical species.

10. The reagent according to claim 9, wherein the second chemical species is acid.

11. The reagent according to claim 2, wherein the first chemical species is generated unimolecularly from the reagent.

12. The reagent according to claim 2, wherein the first chemical species is generated from the reagent without any interaction with another molecule.

13. The reagent according to claim 2, wherein the first chemical species is not generated from the reagent when the reagent is irradiated with a light the energy of which is sufficient to excite to the lowest singlet excited state of the reagent by one-photon absorption.

14. A composition, comprising:
the reagent according claim 3; and
at least one compound selected from the group consisting of the at least one kind of monomer, and a compound having a protecting group that can be protected.

15. A method for fabricating an object, the method comprising:
putting the composition according to claim 14 on a substrate; and
irradiating the composition.

16. The method according to claim 15, wherein irradiating the composition is carried out such that:
polymerization of the at least one kind of monomer occurs at the focal positions; or
the deprotection reaction of the compound occurs at focal positions.

17. The method according to claim 15, wherein irradiating the composition is carried out by making the reagent absorb a plurality of photons, each of which does not have enough energy to excite to the lowest singlet excited state of the reagent.

18.-23. (canceled)

24. The reagent of claim 3, wherein the reagent is an ethene derivative including at least one aromatic ring and a halogen atom on the at least one aromatic ring.

25. The reagent of claim 3, having the formula: 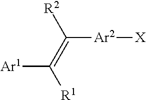
wherein:
X is any one selected from the group consisting of F, Cl, Br, and I;
each of Ar¹ and Ar² is independently selected from the group consisting of an aryl group selected from the group consisting of a substituted or unsubstituted phenyl group, a substituted or unsubstituted naphthyl group, a substituted or unsubstituted anthryl group, a substituted or unsubstituted pyrenyl group, a substituted or unsubstituted phenanthryl group and a substituted or unsubstituted perylenyl group; a substituted or unsubstituted heterocyclic group; and a group including the aryl group and at least one double bond connected to the aryl group;
each of R¹ and R² is independently selected from the group consisting of a hydrogen atom, a halogen atom, an alkyl group, an alkenyl group, an alkynyl group, an aryl group and a heterocyclic acid; and
the alkyl group, the alkenyl group, the alkynyl group, the aryl group and the heterocyclic acid may include at least one halogen atom.

26. The reagent of claim 3, wherein the homolytic bond fission initiates a deprotection reaction of a compound having a protecting group.

27. The method according to claim 15, wherein irradiating the composition is carried out such that a focal position of a light used in the irradiation is three-dimensionally controlled.
